(19) United States
(12) Patent Application Publication
(10) Pub. No.: US 2005/0016303 A1
(43) Pub. Date: Jan. 27, 2005

(54) Sealing device

(76) Inventors: Paul Anthony Jacobs, Chesterfield (GB); John Thomas Bright, Nr Doncaster (GB); Alan James Roddis, Chapetown (GB)

Correspondence Address: MYERS BIGEL SIBLEY & SAJOVEC, PO BOX 37428, RALEIGH, NC, 27627, US

(21) Appl. No.: 10/693,611

(22) Filed: Oct. 24, 2003

(30) Foreign Application Priority Data
Oct. 25, 2002 (GB) GB0224862.3

(51) Int. Cl. G01M 19/00

(52) U.S. Cl. 73/865.9; 73/49.8; 277/317

(57) ABSTRACT

A sealing device for rotating equipment includes one or more sensors and one or more data storage devices. The sensorw are arranged to receive variable information relating to the performance of the dealing device and to feed the information to the storage device or devices.

### RELATED APPLICATION

This application claims priority to Great Britain Patent Application No. 0224862.3, filed Oct. 25, 2002, the disclosure of which is hereby incorporated herein by reference.

### FIELD OF THE INVENTION

This invention relates to mechanical seals, which are fitted to rotating equipment in virtually all types of industries.

### BACKGROUND OF THE INVENTION

A mechanical seal comprises a “floating” component which is mounted for axial movement around the rotary shaft of, for example, a pump and a “static” component which is axially fixed, typically being secured to a housing. The floating component has a flat annular end face, i.e. its seal face, directed towards a complementary seal face of the static component. The floating component is urged towards the static component to close the seal faces together to form a sliding face seal, usually by means of one or more spring members. In use, one of the floating and static components rotates; this component is therefore referred to as the rotary component. The other of the floating and static components does not rotate and is referred to as the stationary component.

Those seals whose floating component is rotary are described as rotary seals. If the floating component is stationary, the seal is referred to as a stationary seal.

If the sliding seal between the rotary and stationary components is assembled and pre-set prior to despatch from the mechanical seal manufacturing premises, the industry terminology for this is “cartridge seal”. If the rotary and stationary components are despatched individually (unassembled) from the mechanical seal manufacturing premises, the industry terminology for this is “component seal”.

Mechanical seals are used in all types of industries to seal a variety of different process media and operating conditions. The general industry term which defines the area adjacent to the process media is “inboard”. The industry term which defines the area adjacent to the atmospheric side is “outboard”.

Customer service is one of the key elements, which differentiates companies competing in the same industrial sectors. Companies which embrace and develop products and technologies that help them improve their service levels to their customers, are more likely to grow or survive in a highly competitive world.

One such way of improving a service to a customer, is the ability to predict the performance of the supplied product, given a complex situation. A complex situation is one where there are many variables that can affect the performance of a product. Such variables may be predictable, or as often found, they are unpredictable. In the mechanical seal industry, such unpredictable variables or events include process pressure spikes, high/low thermal process excursions, equipment seizure or support service failure.

Such unpredictable variables suggest that a product, which has the intelligence to be able to detect and interact with data from a complex situation, will be of great value to a customer or user of that product.

Further advantages may be realised if the product is used in a complex and highly sensitive application. A sensitive application is defined as one in which product failure must be avoided. An example of such a sensitive application is given as a mechanical seal used to seal a reactor of a nuclear process. If the mechanical seal unpredictably fails, the resulting loss of production or damage to the environment could be incalculable.

Rotating equipment includes pumps, mixers, reactors, agitators, basically any item of equipment, which pumps or mixes a product media. All items of rotating equipment need sealing to prevent the pumped media from escaping. Mechanical seals are used for such applications.

In certain circumstances, the user may not know exactly what the rotating equipment duty is for an application. It is very difficult to calculate exact pressure and temperature variables at the mechanical seal position in the rotating equipment. Furthermore, these variables can change over the life of the rotating equipment.

Measuring such variables is of vital importance so that the user can, for example, select the correct mechanical seal for the application. The reader should note that most mechanical seal failures are as a result of process variable upsets. Understanding what was the cause of a seal failure, is a difficult task without actual process measured variable data, especially data measured at the seal position.

Manual tracking of the possible process variables, using conventional measuring techniques at plant level, for each mechanical seal is often an impossible task. This task is further complicated if the variables are constantly changing, and/or if the mechanical seal and/or support system variables are included in the calculation.

### SUMMARY OF THE INVENTION

According to the present invention, there is provided a sealing device for rotating equipment, said sealing device incorporating one or more sensors and one or more data storage devices, said sensor or sensors being arranged to measure variable information relating to the performance of the sealing device and to feed said information to said storage device or devices.

The present invention also provides a method of monitoring the performance of a sealing device for rotating equipment, the method comprising measuring variable information by means of a sensor or sensors incorporated by the sealing device, and feeding said information to one or more data storage devices.

Preferably the information located in the storage device or devices is, optionally after modification, displayed on display means.

The present invention enables the user to locally and remotely monitor the rotating and static mechanical seal variables at plant level. The user can locally and remotely detect and predict mechanical seal failure prior to it occurring. The user can therefore remedy the problem or planned outage before the seal catastrophically fails causing substantial damage and loss of process media.

Allying the complex real world problems with mechanical seals to electronic data collection and software modelling techniques provides the user with predictive and historic data sets upon which complex decisions can be based. RFID, RFDC and micro-controllers are enabling technologies for such a system. Electronics are now becoming available which incorporate the RFID function with sensor monitoring capability.

### BRIEF DESCRIPTION OF THE DRAWINGS

The accompanying drawings are as follows:

FIG. 1 illustrates a circuit combining RFID with sensor monitoring capability;

FIGS. 2A and 2B are, respectively, front and side views of a typical rotating equipment assembly, such as a centrifugal pump, fitted with a single rotary cartridge mechanical seal of the invention;

FIG. 3 shows an enlarged partial cross section of the single rotary mechanical seal shown in FIG. 3;

FIG. 4 shows an enlarged view of the stationary seal face strain measurement device of the seal of FIG. 2;

FIG. 5 shows an enlarged view of an alternative stationary seal face strain measurement device;

FIG. 6 shows an enlarged view of a further alternative stationary seal face strain measurement device;

FIG. 7 shows a partial cross section of a double stationary seal with a seal face sensor arrangement;

FIG. 8 shows an enlarged view of part of the seal of FIG. 3, including the drive screw with strain gauge/resistance attached;

FIG. 9 shows an enlarged view of an alternative arrangement of drive screw with a linear displacement transducer sensor attached;

FIG. 10 shows an enlarged view of an alternative arrangement of drive screw with a proximity sensor attached;

FIG. 11 illustrates schematically an intelligent sealing system of the invention;

FIG. 12 illustrates schematically a remote receiver unit of the invention;

FIGS. 13A and B show, respectively, front and bottom views of a remote receiver unit of the invention;

FIG. 14 shows schematically a remote receiver with a supplementary power supply;

FIGS. 15A and B show an alternative remote receiver unit having the components shown in FIG. 14;

FIG. 16 is another view of the remote unit of FIG. 15 and including a detachable rechargeable battery unit; and

FIG. 17 illustrates a flow chart for the data acquisition software in a system of the invention.

### DETAILED DESCRIPTION OF THE PREFERRED EMBODIMENTS

The invention will now be further described, by way of examples only, with reference to the accompanying drawings.

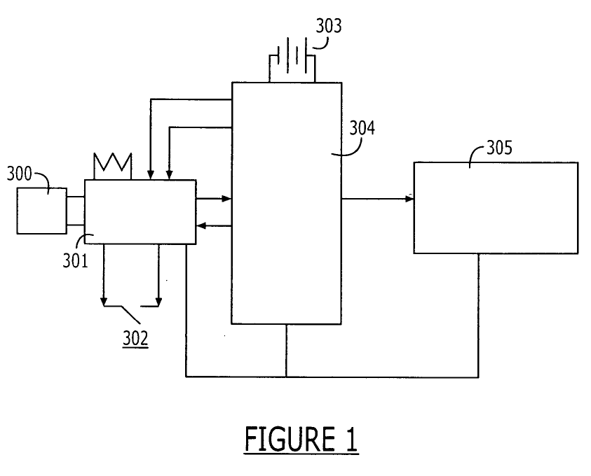

As illustrated in FIG. 1, signals from sensor 300 are conditioned in the IC device with its own ID 301 and the values are read by the micro-controller 304. The data from the micro-controller 304 can be transmitted by the RF transmitter. The system is powered from the battery 303.

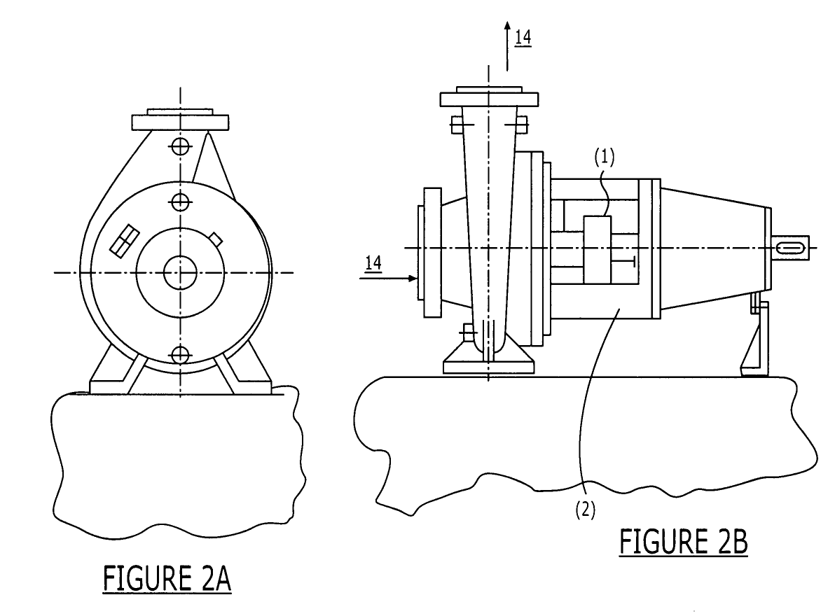

From FIG. 2 a mechanical seal assembly 1 of the invention is installed on a rotating piece of equipment 2. The purpose of the mechanical seal assembly 1 is to prevent process media 14 escaping from the rotating equipment 2.

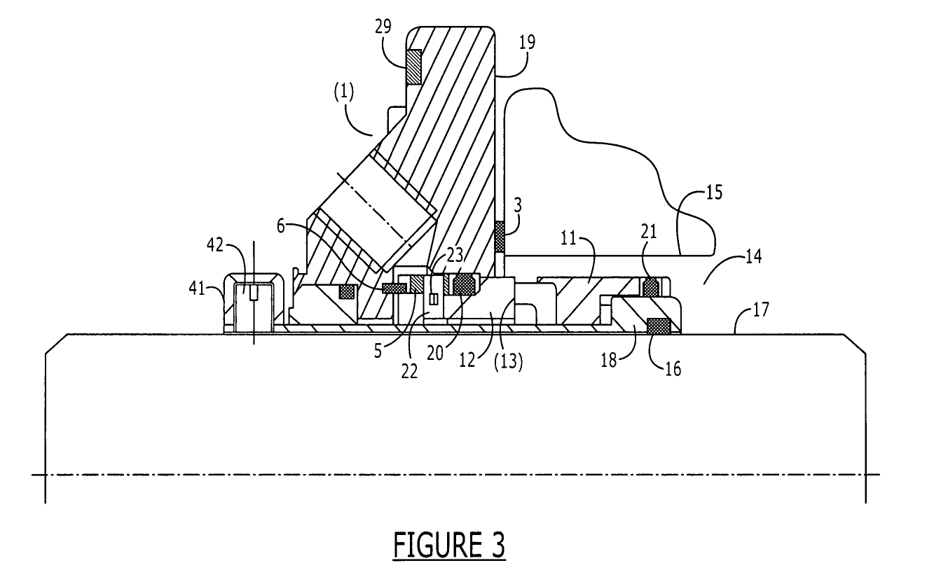

Referring to FIG. 3, the rotary and axially floating seal face 11 is spring biased towards a static stationary seal face 12. The rotary seal face 11 is allowed to slide on the static seal face 12. The interface between the rotary seal face 11 and stationary seal face 12 forms sealing area 13. This sealing area 13 is the primary seal that prevents the process media 14 from escaping from the process chamber 15.

In addition to the sliding seal face 13, the process media 14 is sealed by a sleeve elastomer 16 in contact with the shaft 17 and sleeve 18. This has been termed the first secondary sealing area.

The second secondary sealing area is formed between stationary seal face 12 and stationary gland plate 19 using elastomeric member 20.

The third secondary sealing area is formed between the rotary seal face 11 and the sleeve 18 using elastomeric member 21.

The fourth secondary sealing area is formed between the gland plate 19 and the process chamber 15 using gasket 3.

The four secondary sealing devices 16, 3, 20 and 21 and the primary sliding sealing interface 13 prevent the process media 14 from escaping from the process chamber 15.

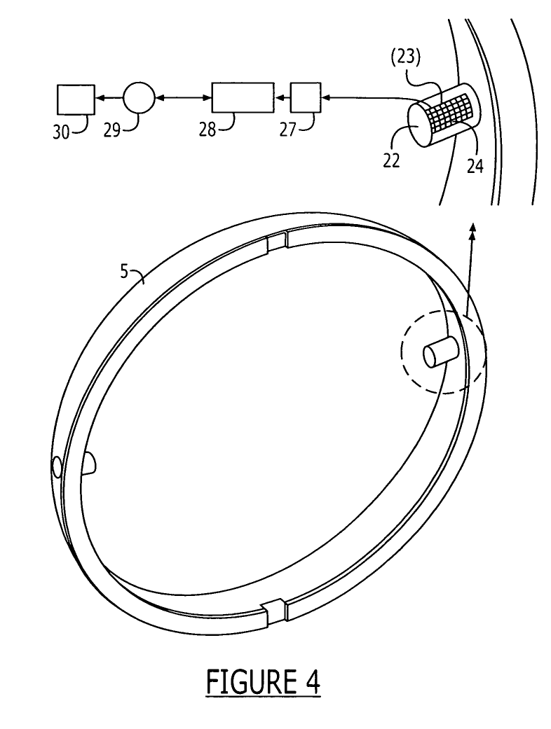

The static seal face 12 is prevented from rotating by at least one anti-rotational pin 22 mounted in the stationary member, in this case a stationary pivot ring 5. The pivot ring 5 is held stationary to the gland plate 19, by one or more anti-rotation features 6. The pivot ring 5 concept is further described in U.S. Pat. No. 4,509,762. Another anti-rotational device may be used such as a pin, slot and lug design. Secured onto the anti-rotational pin 22 is a strain device 23 as shown in FIG. 4.

From FIG. 4, the strain device 23 is permanently attached to the anti-rotation pin 22, preferably by adhesive. However it is understood that any other suitable means could be used, including mechanical attachment, chemical attachment and/or physical such as welding or brazing etc.

The strain device 23 is shown, by way of example only, as a thin, foil like member complete with resistance wire 24, which runs both horizontally and vertically in the foil.

Referring back to FIG. 3, any force, torque or vibration, transmitted from the sealing area 13 to the stationary seal face 12 and then to the anti-rotation pin 22, is monitored as a resistance change in the strain device 23. From FIG. 4, the strain device 23 is connected to an amplifier 27 which in turn is connected to a micro-controller 28, volatile memory 29 and RF transmitter 30. The resistance change from the strain device 23 is amplified by the amplifier 27 and a signal sent to the micro-controller 28. The micro-controller 28 poles the data by checking or comparing the signal information to a benchmark reading and then date and time stamps it. The time-logged information is then saved in volatile memory 29. Two-way communicating RF transmitter 30 is employed so data can be saved and retrieved. RF transmitter 30 could be any wireless device. Clearly, the transmission of data could also be by means of hard wired technology.

By the above described arrangement, the force applied to the anti-rotation pin 22 can be recorded at periodic intervals, time logged and saved in memory 29. This force can be evaluated against a benchmark force. Upper and lower force idealised limits can be established for different applications. Measured force limits can be compared to idealised seal sliding surface forces and a precise assessment of the seal face 13 conditions can be made by the user.

Strain is one of many physical parameters that can be measured, recorded and compared against benchmarks indicative of satisfactory mechanical seal performance. Others include temperature, pressure, humidity, and vibration.

The above described arrangement can therefore provide an indication of whether or not the seal 1 is performing well. This information can be used in a preventative maintenance program to provide an early warning of future seal 1 failure.

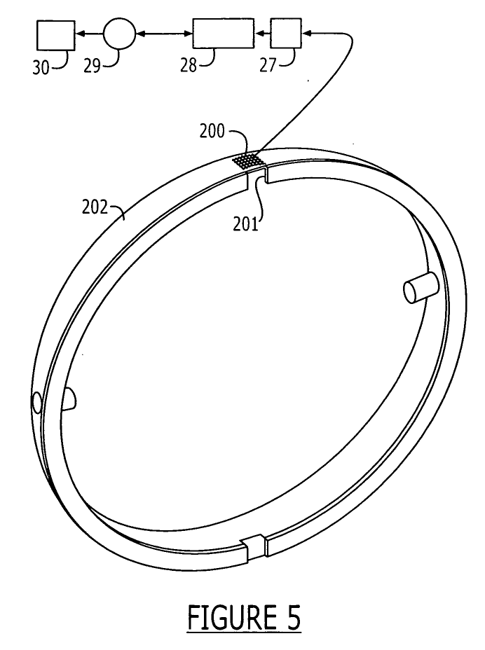

FIG. 5 shows an enlarged view of an alternative stationary seal face strain measurement device 200, which is a strain/resistance gauge attached on or near to the drive slot 201 on drive plate 202.

The strain device 200 is permanently attached to the plate 202, preferably by adhesive. However it is understood that any other suitable means could be used, including mechanical attachment, chemical attachment and/or physical such as welding or brazing.

The position of the strain device 200 is ideally adjacent to a drive slot 201 or important feature on the drive plate 202. This arrangement therefore allows the measurement of stress in said drive plate 202 at any point. Clearly, such measurement devices could be positioned at any point within the mechanical seal 1 as deemed appropriate.

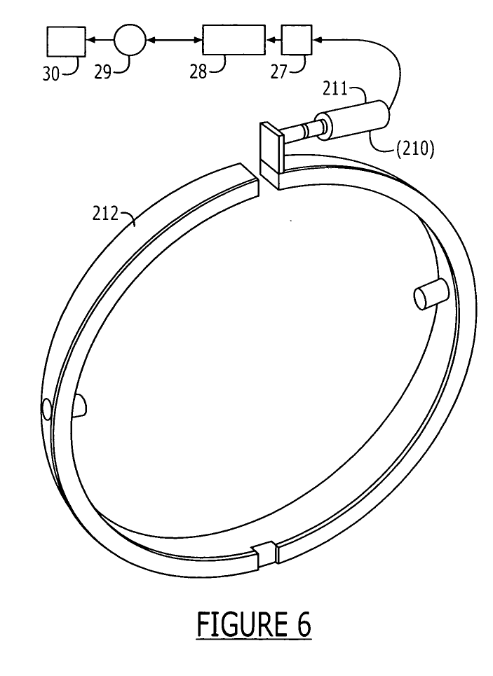

FIG. 6 shows an enlarged view of an alternative stationary seal face strain measurement device 210, which is a linear gauge 211 attached to a split drive ring 212. Torque is transferred from the sealing arrangement into said split drive ring 212.

The split drive ring 212 has a direct amplification effect on the measured sensory reading 211. This direct amplification effect improves the accuracy of the measurement since said measurement can be further electronically amplified as described previously.

The sensory devices shown in FIGS. 5 and 6 are connected to an amplifier 27, micro-controller 28 and memory 29 as previously described.

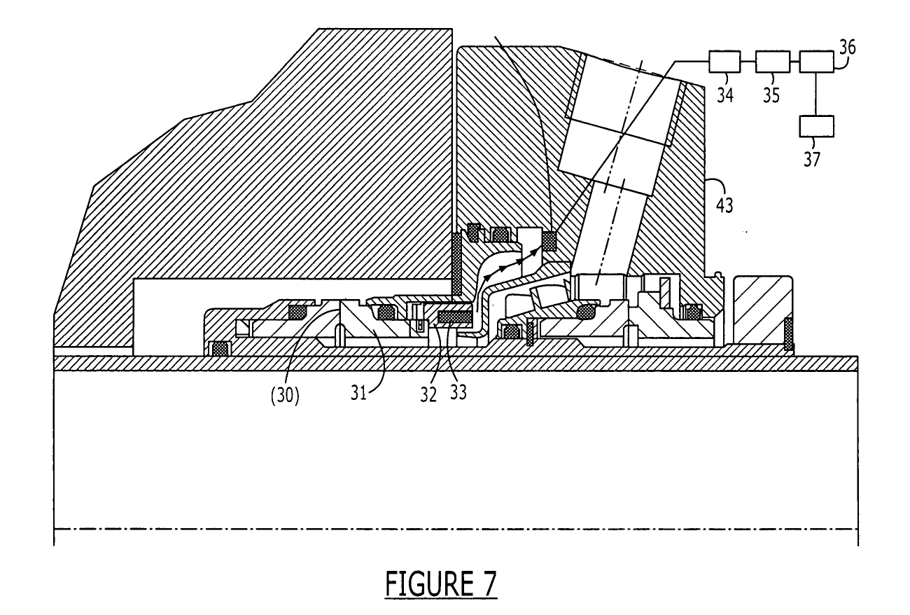

FIG. 7 shows a partial cross section of a double stationary mechanical seal 43 with an alternative seal face sensor arrangement. Any force, torque or vibration transmitted from the sealing area 30 to the stationary seal face 31 and then to the spring plate 32, is monitored by a displacement transducer 33.

The displacement transducer 33 is connected to an amplifier which in turn is connected to a micro-controller 35, memory 36 and RF transmitter 37. The axial displacement change from the transducer 33 is amplified by the amplifier 34 and a signal sent to the micro-controller 35. The micro-controller 35 poles the data by checking or comparing the signal information to a benchmark reading and then date and time stamps it.

The time-logged information is then saved in volatile memory 36. Clearly a read and write RF transmission 37 is employed so data can be saved and retrieved. The two aforementioned examples clearly show how one or more mechanical seal faces can be precisely measured by one or more sensors to determine the actual operating conditions at said seal faces.

There are other parts of the mechanical seal which benefit from this intelligent system of the invention. Examples of such features are now described.

From FIG. 3, the sleeve 18 is axially terminated adjacent to the clamp ring 41 which contains at least one drive screw 42 for securing the seal assembly 1 to the shaft 17. Said drive screw 42 provides rotational drive from shaft 17 to the rotary components in the seal assembly 1.

Occasionally the vibration from the rotating equipment can cause the drive screw 42 to become loose. This results in premature seal 1 failure which can be a very expensive problem. This drive screw 42 loosening process typically occurs over a period of time while the shaft 17 of the rotating equipment is rotating. Since the shaft 17 is rotating the drive screws 42 can not be checked without stopping the shaft. This, in most circumstances, is not practical. Furthermore, if a plant has 30,000 pieces of rotating equipment, it is impossible to stop and check every mechanical seal drive screw 42.

The present invention may also be applied to at least one drive screw 42 to provide an early indication of drive screw 42 loosening.

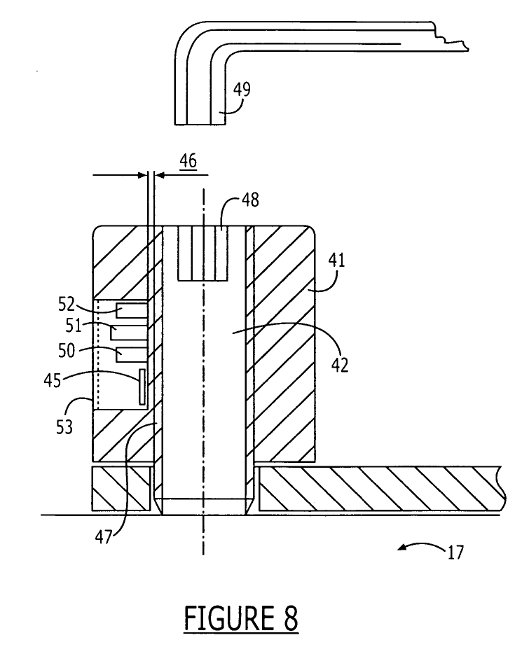

FIG. 8 shows an enlarged view of the drive screw 42 with strain gauge 45 attached.

A foil type strain gauge 45 is secured onto the axial side of the clamp ring 41 adjacent to each drive screw 42. The axial material length 46 of clamp ring 41 between the strain gauge 45 and drive screw threaded hole 47 is ideally less than 1 mm. This helps to improve the accuracy of the strain gauge 45 reading, since the material is weaker at this point thereby amplifying the strain gauge reading. However, this small amount of axial material 46 is not essential.

In normal operation, the drive screw 42 is screwed into the clamp ring threaded hole 47 until it meets the shaft 17 of the rotating equipment. As the drive screw 42 contacts the shaft 17, a torque is applied by the user, to the drive end 48 of the drive screw 42. Typically a hexagonal cross section Allen key 49 is used to apply the torque. This mechanically secures the drive screw 42 to the shaft 17.

This arrangement of drive screw 42 inserted in a threaded hole 47 produces an equal and opposite force which is transmitted from the drive screw 42 into the clamp ring 41. This force has the effect of stressing the material of the clamp ring 41 very slightly adjacent to the drive screws 42. This material stress is monitored by the strain gauge 45. A change in resistance for each strain gauge 45 positioned adjacent to each drive screw 42 is noted. This change in resistance can be correlated to the torque applied by the user, for any size of drive screw 42.

As previously described, the strain gauge 45 is connected to an amplifier 50 which in turn is connected to a micro-controller 51 and memory 52. Said micro-controller 51 and memory 52 are mounted in a leak tight capsule 53 and secured to the clamp ring 41. Clearly, said capsule 53 may be sunk into the clamp ring 41 recess or hole, thereby preventing it from being damaged or knocked off.

The resistance change from the strain gauge 45 is amplified by the amplifier 50 and a signal sent to the micro-controller 51. The micro-controller 51 poles the data by checking or comparing the signal information to a benchmark reading and then date and time stamps it.

The time-logged information is then saved in memory 52. Again two way RF transmission is employed to transmit and/or receive data.

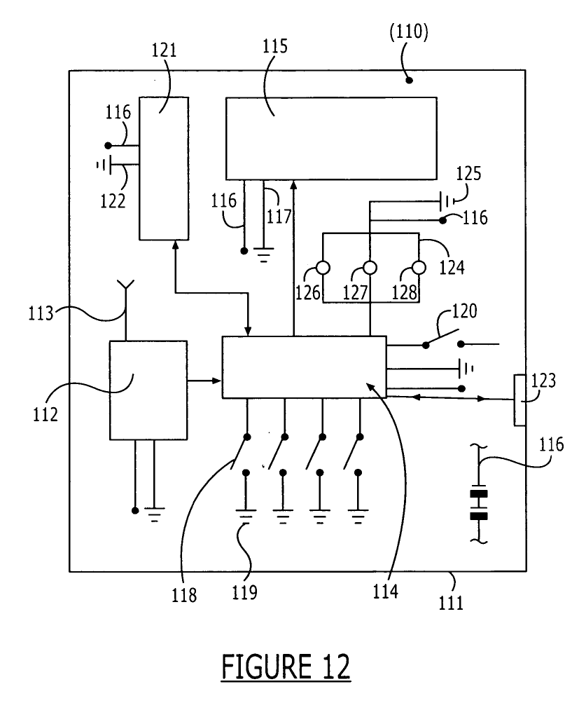

This system of the invention can be used to allow the user to set the torque of each drive screw 42 to a precise displayed reading by using a remote hand held device. This remote hand held device will be described later with reference to FIGS. 12 to 16.

Since the foil strain gauge is secured on the clamp ring adjacent to each drive screw 42, if the drive screws 42 start to come loose in operation, then a change in resistance will be observed by the strain gauge 45. This may be detected by the user allowing the equipment to be stopped before catastrophic mechanical seal failure 1.

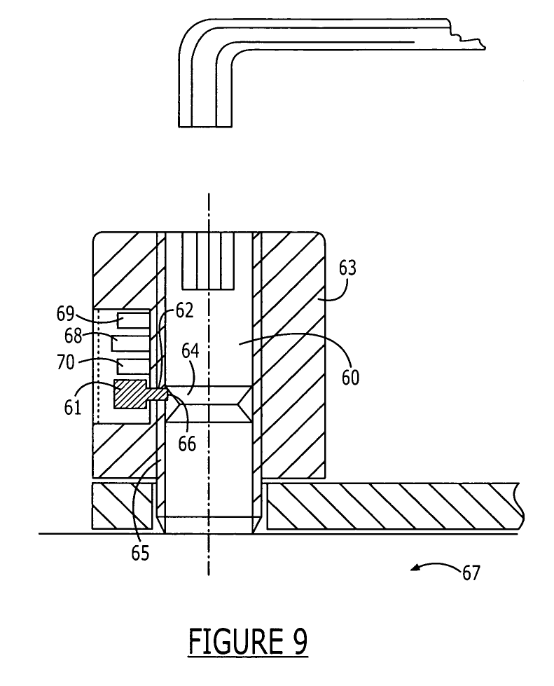

There are many methods by which the drive screws can be monitored. Various sensor devices can be employed, some more effective than others in different applications. FIG. 9 shows another configuration of a system to measure the clamping force of the drive screw 60 using a cylindrical linear displacement transducer 61 which is secured into a hole 62 of the clamp ring 63. The linear transducer 61 protrudes slightly from the hole 62 and makes contact with a corresponding taper 64 on the drive screw 60.

As the drive screw 60 is screwed in the threaded hole 65, the nose 66 of the transducer 61 deflects axially inwardly, therefore preventing damage. The drive screw contains a tapered surface adjacent to the linear transducer position. When the drive screw 60 contacts the shaft 67, an equal and opposite force is transmitted through the drive screw 60 into the threads of the clamp ring 63. This force creates a slight linear displacement of the drive screw 60. Once the drive screws 60 are torqued to the required level, the linear transducers 61 are set to a zero measurement. Any relaxation in the drive screw securing torque will register as a linear deviation on the transducer 61. Again, the linear transducer 61 will be connected to amplifier 70, a micro-controller 68 and memory 69, allowing the user to determine when the drive screw 60 torque relaxation took place.

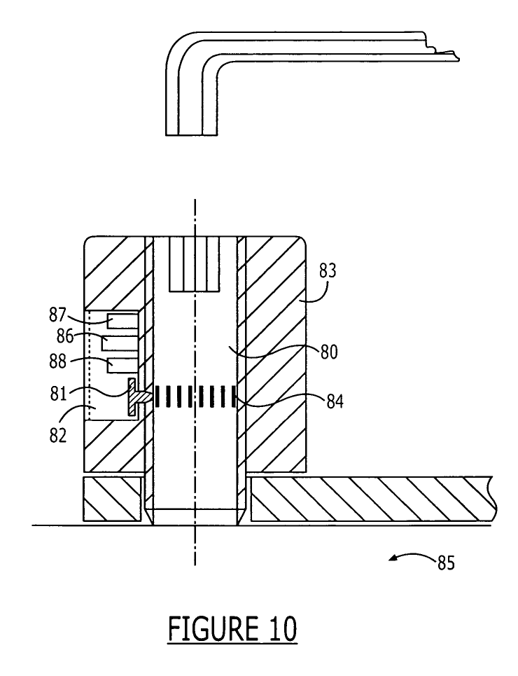

FIG. 10 illustrates a further alternative approach to determine if a drive screw 80 loosens in operation. A proximity sensor 81 is secured into a hole 82 of the clamp ring 83. The proximity sensor 81 is positioned adjacent to a series of small integral sensing elements 84 of the drive screw 80. These sensing elements 84 are equally spaced around the circumference of the drive screw 80.

When the drive screw 80 is secured to the shaft 85, the proximity sensor 81 notes the proximity between it and the sensors on the drive screw 80. If the drive screw 80 becomes loose, the proximity between sensors 84 and proximity sensor 81 will change. This signal is again passed to an amplifier 88, a micro-controller 86 and stored memory 87.

Other types of sensor devices, not just strain/resistance gauges, proximity sensors or linear and non-linear transducers, can be employed by the intelligent system of the invention. Sensory data acquisition may be collected using a number of devices for different applications. By way of examples only, sensors include:
temperature fluctuations using thermal sensors;
pressure fluctuation using pressure transducers;
force fluctuations using stress, strain and/or force transducers;
humidity using moisture sensors;
vibration using accelerometers;
resistively using resistance gauges; and
movement using linear displacement transducers.

By way of example, some of the possible sensor applications, of the invention, are discussed below.

Information about the temperatures of critical components and areas within the mechanical seal is of fundamental importance in the monitoring of the operating conditions of the seal and in the prediction of malfunctions. Recent European legislation regarding the provision of mechanical equipment for use in explosive atmospheres increases the requirements for the monitoring of such equipment.

The temperature of the pumped fluid, whilst relatively simple, will not necessarily yield the correct information regarding the operating conditions of the sealing components. For example, the temperatures at, or near, the sealing faces will differ markedly from that of the bulk temperature of the pumped fluid.

Temperature sensing devices may be used to sense the temperatures at or within various components of the seal assembly. In one such embodiment a temperature sensor is embedded in a drilling or cavity in the static stationary sealing face. This arrangement allows of the sensing of the temperature in very close proximity to the point of contact between the rotary and stationary sealing surfaces.

The external surface temperature of the seal assembly is also measured by a suitable temperature sensing device. In the invention this may take the form of any temperature sensor including those designed to work in a non-contact mode.

The secure attachment of a temperature sensing device is preferably by an adhesive either in its cavity or, in the case of a non-embedded temperature sensing device, to a surface. However, any suitable fixing method may be employed including, welding, brazing or mechanical fasteners.

A thermocouple is the preferred type of temperature sensing device for the embedded sensor application but other types of contact temperature sensors can be used.

All seals leak to some extent as part of their normal operation. This leakage, on a normally operating seal, is very small. In many cases, as the seal faces wear or prematurely suffer some damage to their surfaces, the level of leakage increases over a period of time before reaching an unacceptable level. Unless regular inspection is carefully carried out, the onset of leakage from a mechanical seal may go unnoticed leading to unscheduled down-time when finally the seal must be taken out of service due to excessive amounts of leakage.

Therefore, for reasons of both economy and safety the ability to identify seal leakage from its onset is highly beneficial. In the present invention leaks are detected by a humidity sensor placed in communication with the leak path behind the seal faces. Leakage of product across the seal faces increases the humidity of the atmosphere around the humidity sensor. This increase in humidity is detected by the sensor indicating that the seal is leaking. The triggering level of the output signal may be adjusted to prevent spurious alarms and give reliable leak indication.

Other types of sensors may be used to detect the presence of leakage dependent upon the characteristics of the process fluid.

For equipment operating in hazardous areas the presence of explosive gases or vapours, either escaping from the sealed equipment or from neighbouring equipment, may present a considerable hazard. In the present invention the use of combustible gas detectors in the immediate vicinity of the seal or suitably positioned in the vicinity of the sealed equipment are used to monitor the atmosphere for the presence of flammable gas. Types of combustible gas detectors which may be used include catalytic, thermal conductivity or non-dispersive infrared.

Should the atmosphere around the combustible gas detector become contaminated by the presence of a flammable gas the output from the detector will change. This change in the output from the detector will be amplified and used to raise an alarm warning of the presence of flammable gas.

The alarm signal from the detector may be fed to a micro-controller for further discrimination of the signal such as, by way of example only, comparison of the signal with a benchmark value. Furthermore an algorithm can be used to determine the level of alarm and/or the subsequent action to be taken.

A combustible gas detector can also be configured to monitor for and provide a record of the emissions of VOCs from items of equipment around refineries or processing plants.

It will be appreciated that the examples of intelligent instrumentation of the invention described above may be used singly or in combinations, for instance, arranged in groups or provided in modular form, giving rise to various options.

The components of a system of the invention may be designed for use in intrinsically safe applications or adapted for flameproof operation in applications where such levels of safety are requisite.

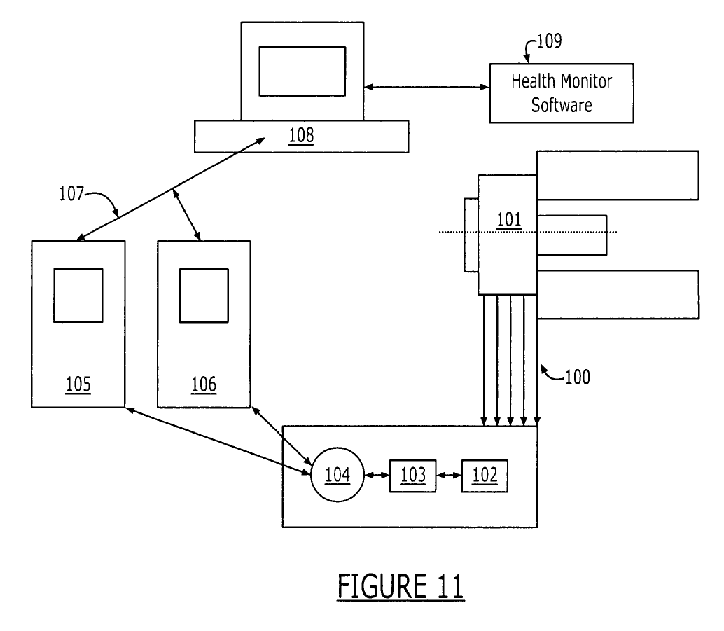

FIG. 11 illustrates a schematic of an intelligent sealing system of the invention. Signals from any number of the sensors 100, located in the mechanical seal 101, are fed into at least one micro-controller 102. The micro-controller 102 processes the data and stores it in memory 103. Data samples are taken over the most appropriate time intervals.

Users in large plants can install a local health monitor repeater 105 around the plant. This remotely scans the respective RF transmitters 104. Each RF transmitter 104 has a unique wireless connectivity or reference code so that the user is able to separate gathered information from more than one piece of equipment.

The local remote health monitor repeater 105 then transmits the information by wireless technology to a network 107 and/or internet server 108 using health monitor software 109. The health monitor signal can be further processed to provide control of the process and prime movers if so required. Portable receivers 106 can also be used to collect health monitor data and connect to network 107, server 108 and health monitor software 109.

For the purpose of this application, wireless technology includes, but is not limited to Internet, Satellite, WAP (wireless application protocol) phones, LAN (local area network), WLAN (wireless local area network), field bus connector, WEP (wireless encryption protocol) and bluetooth. Clearly hard wire technology can also be employed. The technology also allows the health monitor software to dial and send a message to a mobile cell phone, if required.

FIG. 12 illustrates a schematic of a remote receiver unit invention. The remote receiver 110 is employed by the user to review the health status on a particular rotating equipment application as the user attends site. The receiver 110 comprises a series of components situated inside a casing 111.

The RF receiver 112 is connected to a RF aerial/external antennae 113. The RF receiver 112 receives the sensor data from the application, which is stored in memory previously described. The RF receiver 112 sends the data to a micro-controller 114. The micro-controller 114 sends the information to a VFD display 115 which is connected to a suitable power supply, in this case a battery 116. The display 115 is also connected to an earth terminal 117.

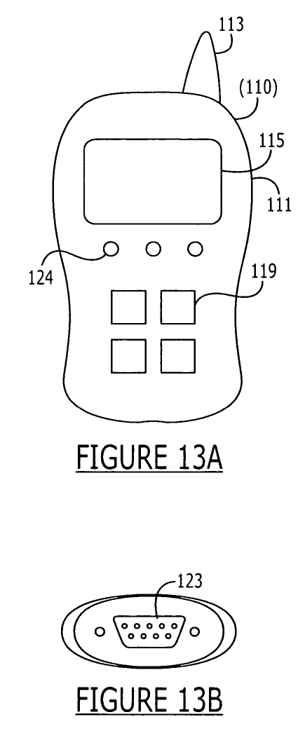

The micro-controller 114 is preferably connected to one or more user control switches 118. Switches 118 are connected to user control buttons 119 also illustrated in FIG. 13A. Switches 118 are also connected to an earth terminal 119.

The micrcontroller 114 is connected to a power switch 120 which, if activated, connects the circuit to the power supply 116 therefore providing user operating power to the micro-controller 114. Furthermore, the micro-controller 114 is connected to an external EEP ROM (electrically erasable programmable read only memory) data storage device 121, which in turn is connected to the power supply 116 and earth terminal 122. This allows the user to save collected data, which at a later date can be transferred through the 9 pin D-Type RS232 serial connector 123 to a computer or subsequent data processing device. An alternative connector device 123 such as a 21 pin or 6 pin design, may be used where appropriate.

Preferably, although not essentially, the micro-controller 114 is also connected to an LED (light emitting diode) visual display unit 124, which in turn is connected to a power supply 116 and earth terminal 125. The LED display unit 124 is a user friendly display, which illustrates whether the process application and sensory devices are out of the pre-specified sensor control limits.

At least one LED display 124 unit is employed in the remote unit of the invention, but preferably five LED displays are employed. Said LED displays differentiate high, low and normal conditions. If the application sensor(s) are in the normal control limits, the middle LED displays, if the process sensors are moving towards the control limits, the lower LED displays and if the process sensors are out of the control limits, the upper LED displays.

FIGS. 13A and B illustrate a remote receiver unit 110. The outer casing 111 covers the components and electrical circuit described above with reference to FIG. 12. In addition, a graphic illustration of the display 115, LED display 124, D-Type RS232 connector 123, RFID antennae 113 and user buttons 119 may be seen.

There are many alternative designs of the remote unit 110 having a range of different functions and/or technical sophistication.

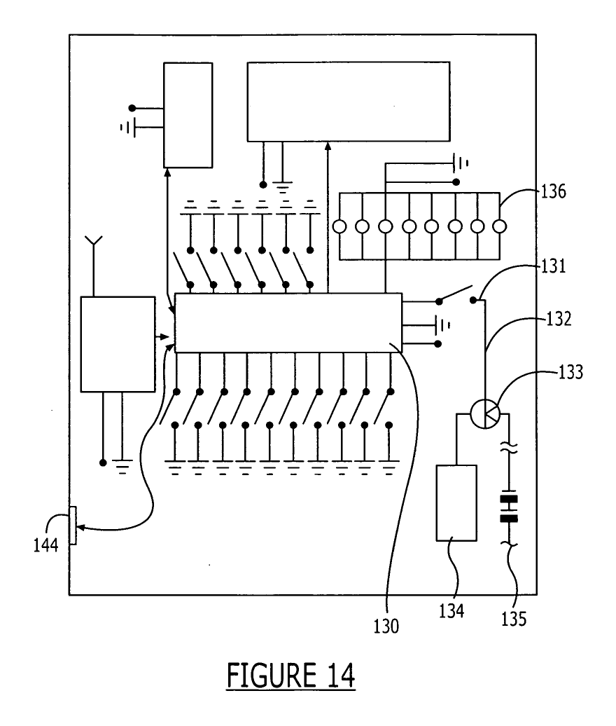

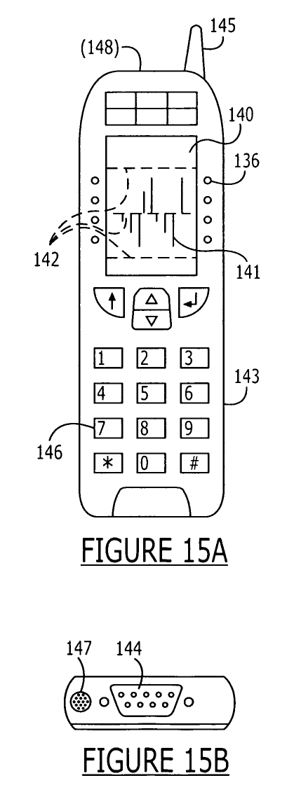

FIGS. 14 and 15 illustrate one such alternative remote unit having increased technical sophistication. FIG. 14 shows a schematic of remote receiver with a supplementary power supply. The micro-controller 130 is connected to a power switch 131 which, if activated connects the circuit to the power supply 132 thereby providing power to the micro-controller 130. The power switch 131 is connected to at least one transistor 133. The transistor 133 is connected to at least two power supplies, the first being a solar cell 134 and the second a battery 135.

When the power switch 131 is activated, the transistor 133 preferably sources power supply from the solar cell 134. In applications where there is insufficient power generated by the solar cell 134, the transistor 133 sources power supply from the battery 135, until such a time when the minimum power level is achieved by the solar cell 134. The transistor 133 then switches the power source to the solar cell 134 thereby elongating the finite battery 135 life.

A rechargeable battery 135 can also be employed. This thereby allows the solar cell 134 to recharge the battery 135 when the battery 135 is not in use.

If there is no solar cell 134 the rechargeable battery 135 can be charged by connecting the device to an AC/DC adapter or portable unit as found in most automobiles.

The unit shown in FIG. 14 includes a large number of LED displays 136. FIG. 14 shows that these can be positioned either side of the display 140 allowing the user to visually display the sensored detail with respect to the control limits 142 on the displayed screen.

Referring to FIGS. 15A and B the unit has an outer casing 143 which houses the components and electrical circuit. The unit also includes a graphic illustration of the display 140, LED display 136, D-Type RS232 connector 144, RF antennae 145, keypad 146 and AC power connector 147. The keypad 146 may provide both alpha and numerical options which would allow the user to program the remote device 148, independent of a separate computer.

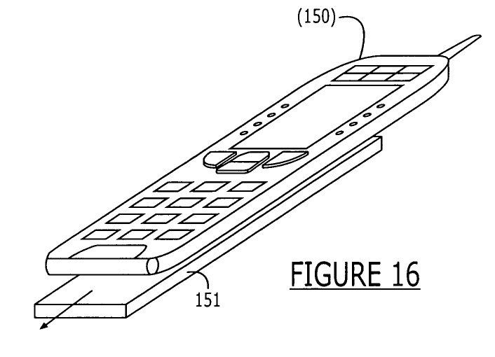

Referring to FIG. 16, an alternative remote unit 150 includes a detachable battery unit 151.

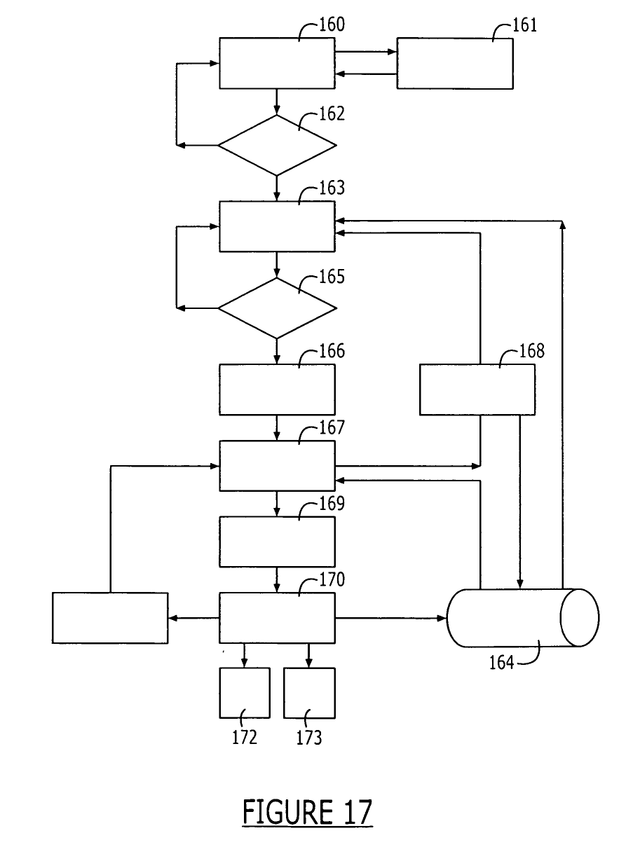

FIG. 17 illustrates a flow chart for the data acquisition software of the invention. The user logs on 160 to the application. If the user does not have an appropriate application password, he/she may apply 161 for one. Once the user password is submitted, the application reviews the user authorisation 162. Certain users may have read only authorisation and certain users may have read and write authorisation. The user then obtains and/or enters the variables for the application into the software 163. Clearly such variables could be retrieved from a database 164 if required.

Said variables are then transmitted to data collection hardware 166. Transmitted data is directed through a security review 165. After the software has checked the data authenticity 165, then item attendant information is collected via RFID or any suitable data transmission device 167. Said data is continuously monitored 168 and can be saved to the database 164 as historical data.

If the user has inputted or retrieved incorrect variable data, the user is directed back to the input area 163.

A software algorithm compares the authenticated input data against the data acquisition stream and/or history 169. The output 170 is then shown as a process health status. The software may then suggest possible remedial actions 171, or allow the user to print 172 and/or send the data to an alternate application 173. The output results are preferably logged in a database 164 for future use.

If remedial action 171 is taken, or if data is entered into the database 164, the application returns the user to the item attendant information collected point 167. The user may reiterate collection and storage sequences until such a time when the user wishes to move onto the next piece of equipment to be measured. At such time, the application sends the user to the variable entering point 163.

The design of the invention can be adapted for intrinsically safe applications also. By way of example only, to achieve this the electronics is designed to run below a certain power/amp level. Alternatively the electronics could be sealed in a media which insulates them. Such a media is, for instance, bitumen.

Flameproof applications are dealt with in a similar manner to the above. The items which could create a spark, or melt/deteriorate under certain thermal conditions, can be sealed in a flameproof container.

The invention, including one or more sensoring devices, may be applied to any type of mechanical seal assembly whether designed as a stationary, rotary, double, single or triple seal, component or cartridge with hydraulically balanced or unbalanced seal faces.

Some single and/or double mechanical seals have a three seal face design, incorporating an intermediate face, which runs between the rotary seal face and stationary seal face. Clearly the invention is applicable for such designs also.

Furthermore, the invention may be applied to complex assemblies operating in fluctuating variable operating conditions for standard or sensitive applications.

Some applications may necessitate very accurate sensory measurements. In such applications the sensors are calibrated and the readings verified, at least once, but preferably in periodic time intervals.

Since a mechanical seal of the invention contains product assembly and/or serial identification data stored on the data storage chip, this information may be used for other purposes. Such purposes include inventory identification, while the product is on shelf, or product tracking, should the product be used for a different application which it was not intended for.

The repair of the product may also be fully tracked. Occasionally, during product repair conventional product identification marks are removed. As the invention has product identification stored on a data storage chip, this could be moulded or enclosed/captured into any number of components within the mechanical seal assembly. This is advantageous for product repair since the original information, including the original manufacturer details, is a permanent element of the construction.

1. A sealing device for rotating equipment, comprising:
at least one sensor;
and at least one data storage device;
wherein said at least one sensor is arranged to measure variable information relating to the performance of the sealing device and to feed said information to said at least one storage device.

2. A device according to claim 1, wherein said information stored is remotely accessible by wireless technology.

3. A device according to claim 2, wherein said wireless technology is RFID, WAP, WEP, WLAN, Bluetooth, Internet, phones and/or satellite.

4. A device according to claim 1, wherein said information stored is remotely accessible by non-wireless technology.

5. A device according to claim 4, wherein said non-wireless technology comprises LAN, Cable, hard wiring and/or a field bus connector.

6. A device according to claim 1, wherein said at least one sensor is connected to an amplifier and/or a micro-controller and one of the at least one data storage device.

7. A device according to claim 6, wherein said one of the at least one data storage device is accessed by a remote unit comprising of a display, and/or keypad and remote antennae or receiver.

8. A device according to claim 1, wherein the at least one sensor is a strain measurement device that is fixed to a component of the sealing device.

9. A device according to claim 1, wherein the at least one sensor is a linear measurement device.

10. A device according to claim 1, wherein said information is processed by a software application configured to advise on remedial actions.

11. A device according to claim 1, wherein the device further comprises:
an axially split drive collar, one end of said split drive collar being fixed to a stationary part of the sealing device and the other end of the split device collar being attached to said at least one sensor device.

12. A device according to claim 1, wherein the at least one sensor and the at least one data storage device are operable to provide feedback control.

13. A method of monitoring the performance of a sealing device for rotating equipment, comprising:
measuring variable information by means of at least one sensor incorporated in the sealing device; and
providing said information to at least one data storage device.

14. A method according to claim 13, wherein the information stored in the at least one storage device is displayed on display means.
